(19) United States
(12) Patent Application Publication
(10) Pub. No.: US 2013/0013091 A1
(43) Pub. Date: Jan. 10, 2013

(54) Network of Heterogeneous Devices Including at Least One Outdoor Lighting Fixture Node

(75) Inventors: Dave Cavalcanti, Mahopac, NY (US); Vasanth Gaddam, Fremont, CA (US)

(73) Assignee: KONINKLIJKE PHILIPS ELECTRONICS, N.V., Eindhoven (NL)

(21) Appl. No.: 13/636,236

(22) PCT Filed: Mar. 11, 2011
(86) PCT No.: PCT/IB2011/051045

§ 371 Date: Sep. 20, 2012

Related U.S. Application Data
(60) Provisional application No. 61/318,527, filed on Mar. 29, 2010.

(51) Int. Cl. G05B 19/00

(52) U.S. Cl. 700/90

(57) ABSTRACT

Methods and apparatus for a scalable network of heterogeneous devices are disclosed. The network may include segment controllers in communication with a remote management system and a plurality of heterogeneous devices such as, for example, lighting fixture nodes and sensors. The segment controllers may transmit sensor data from the sensors to the remote management system. The segment controllers may also transmit control data to the lighting fixture nodes and, optionally, to one or more supplementary nodes. At least some of the control data may be based on data sent from the remote management system and, optionally, the segment controller may generate at least some of the control data independently of the remote management system.

### TECHNICAL FIELD

The present invention is directed generally to a network of heterogeneous devices. More particularly, various inventive methods and apparatus disclosed herein relate to a scalable network of heterogeneous devices that includes at least one outdoor lighting fixture node.

### BACKGROUND

Sensor networks have been proposed that include a plurality of sensors deployed throughout a city to monitor one or more environmental parameters such as, for example, temperature, air quality, sound, and traffic conditions. The sensors in such networks may transmit sensor data to a remote server that processes and analyzes the data. For example, the sensors may include acoustic sensors that monitor environmental sound and transmit sound data to a remote server. The remote server may process the sound data and analyze the data for the occurrence of, for example, a gunshot. If a gunshot is detected the remote server may further analyze the data to determine an approximate origin location of the gun shot.

In order to link the sensors to the remote server in a sensor network, the sensors may form an ad hoc network and cooperate with one another to route sensor data to the remote server. However, such ad hoc sensor networks may not be scalable for city-wide applications. Other sensor networks may additionally or alternatively utilize existing mobile cellular network technologies (e.g., GSM/GPRS, EDGE, WiMax) to link the sensors with the remote server. However, such mobile cellular network connections may not be cost effective since they require a subscription to a service provider for each sensor or grouping of sensors. Moreover, both the ad hoc sensor networks and the sensor networks utilizing the mobile cellular network connections require a large amount of sensor data to be frequently communicated between the sensors and the remote server, potentially leading to inefficiencies in, inter alia, energy usage, cellular network costs, and/or bandwidth. Thus, there is a need in the art for a network architecture that enables efficient and scalable support of a large number of sensors.

Outdoor lighting networks may provide a basis for network architecture for connecting a number of sensors. However, outdoor lighting networks have typically been implemented separately from sensor networks. The outdoor lighting networks are typically self contained and allow for remote management, monitoring, and/or control of outdoor lighting fixture nodes. Each of the outdoor lighting fixture nodes is in communication with and controls at least one outdoor lighting fixture. One or more segment controllers may be included in the outdoor lighting network, with each segment controller being in communication with at least one of the lighting fixture nodes. The connection between the lighting fixture nodes and the segment controller may, for example, take place wirelessly (e.g., directly or via a mesh network), optically, and/or occur over a power line. The segment controller works as a gateway to a remote server and may utilize, for example, existing cellular technologies to establish a connection with the remote server. The remote server may be a remote management system and may allow for monitoring and/or control of the outdoor lighting fixture nodes via the segment controllers. For example, lighting fixture nodes may communicate the presence of a malfunctioning light source in one of the lighting fixtures to the remote server via the segment controllers. Also, for example, the remote server may direct the light output level of each of the lighting fixture nodes through communication with the lighting fixture nodes via the segment controllers.

Existing outdoor lighting networks often implement proprietary communication protocols that are not open to other devices. The underlying connectivity technology utilized in the outdoor lighting networks may be generic (e.g., IEEE 802.15.4, standard or proprietary power-line communication schemes). However, the control protocols running on the lighting nodes and/or segment controllers do not recognize devices that are not part of the outdoor lighting network. Additionally, current application protocols used in outdoor lighting networks only implement lighting controls and/or lighting maintenance and do not recognize data of or support control of non-lighting devices. Accordingly, existing outdoor lighting networks are typically self contained and implemented separately from any sensor or other networks. Moreover, existing outdoor lighting networks may not provide acceptable efficiencies and/or scalability for integration with other heterogeneous devices.

Thus, there is a need in the art for a network that combines a large number of sensors and/or other heterogeneous devices and an outdoor lighting network having at least one outdoor lighting fixture node, wherein the network enables efficient and/or scalable support of the outdoor lighting fixture node, the sensors and/or other heterogeneous devices.

### SUMMARY

The present disclosure is directed to inventive methods and apparatus for a network of heterogeneous devices, and, more specifically, to a scalable network of heterogeneous devices that includes at least one outdoor lighting fixture node. The network enables efficient and scalable support of the heterogeneous devices and the at least one outdoor lighting fixture node. For example, the network may include segment controllers in communication with a plurality of sensors, a plurality of lighting fixture nodes, and a remote management system. The segment controllers may transmit sensor data from the sensors to the remote management system, transmit lighting control commands to the lighting fixture nodes, and transmit lighting fixture status data from the lighting fixture nodes to the remote management system. The segment controllers may locally process at least one of the sensor data and the lighting fixture status data, thereby transmitting less than all of the data to the remote management system. The segment controller may optionally be in communication with one or more supplementary nodes such as, for example, a security system node, a traffic system node, and/or an emergency response system node. The segment controller may transmit control data to at least one of the supplementary nodes and/or at least one of the lighting fixture nodes. At least some of the control data may be based on data sent from the remote management system and, optionally, the segment controller may generate at least some of the control data independently of the remote management system.

Generally, in one aspect, a scalable network of heterogeneous devices includes a plurality of outdoor lighting fixture nodes, a plurality of segment controllers, at least one gateway, at least one remote control station, and a plurality of sensors. Each of the outdoor lighting fixture nodes controls at least one light output characteristic of at least one outdoor lighting fixture. Each of the segment controllers transmits lighting fixture control data to at least one of the outdoor lighting fixture nodes. The light output characteristic of the at least one outdoor lighting fixture is based at least in part on the lighting fixture control data. The gateway is in communication with at least two of the segment controllers and the remote management system. The remote management system is in communication with the segment controllers via the gateway. The remote management system transmits segment controller data to the segment controllers and at least some of the lighting fixture control data is based at least in part on the segment controller data. The sensors transmit sensor data to at least one of the segment controllers. The segment controllers transmit remote system data to the remote management system via the gateway. The remote system data includes information indicative of the sensor data. The segment controllers locally process at least some of the sensor data and thereby include less than all of the sensor data in the remote system data. The segment controller directly determines at least some of the lighting fixture control data based on the sensor data.

In some embodiments, at least some of the sensors transmit the sensor data directly to at least one of the segment controllers. In some versions of these embodiments, some sensors transmit the sensor data to at least one of the segment controllers via at least one of the lighting fixture nodes.

In some embodiments, the segment controllers may operate in an independent mode independently of communication with the remote management system. In some versions of these embodiments in the independent mode of the segment controller the lighting fixture control data is determined independently of the segment controller data.

In some embodiments, the sensors selectively transmit identifying information to at least one of the segment controllers. The identifying information may include type, at least one operation mode, and at least one quality of service (QoS) mode. In some versions of these embodiments the identifying information includes a plurality of the operation mode and a plurality of the quality of service mode. Each segment controller of a plurality of the segment controllers may be in communication with at least one other of the segment controllers.

Generally, in another aspect, a scalable network of heterogeneous devices includes a plurality of outdoor lighting fixture nodes, a plurality of outdoor supplementary nodes, a plurality of segment controllers, at least one remote control station, and a plurality of sensors. Each of the outdoor lighting fixture nodes controls at least one light output characteristic of at least one outdoor lighting fixture. At least one of the outdoor supplementary nodes controls at least one control characteristic of a supplementary non-lighting system such as, for example, a security system, a traffic system, or an emergency response system. A plurality of segment controllers each transmit lighting fixture control data to at least one of the outdoor lighting fixture nodes and transmit supplementary control data to at least one of the outdoor supplementary nodes. The light output characteristic is based at least in part on the lighting fixture control data and the control characteristic is based at least in part on the supplementary control data. The remote management system is in communication with the segment controllers and transmits segment controller data to the segment controllers. At least some of the lighting fixture control data and the supplementary control data are based at least in part on the segment controller data. The sensors transmit sensor data to at least one of the segment controllers. The segment controllers transmit remote system data to the remote management system and the remote system data is indicative of the sensor data. The segment controllers determine at least one of: (a) at least some of the lighting fixture control data and (b) at least some of the supplementary control data, independently of the segment controller data.

In some embodiments, at least some of the sensors transmit the sensor data to at least one of the segment controllers via at least one of the lighting fixture nodes. In some versions of these embodiments at least some other of the sensors transmits the sensor data directly to at least one of the segment controllers.

In some embodiments, the sensors selectively transmit identifying information to at least one of the segment controllers. The identifying information may include type, at least one operation mode, and at least one quality of service mode. The supplementary nodes may additionally or alternatively have the identifying information and selectively transmit the identifying information to at least one of the segment controllers. In some versions of these embodiments, the identifying information includes a plurality of the operation mode and a plurality of the quality of service mode.

The network may further include at least one gateway in communication with at least two of the segment controllers and the remote management system and the gateway may enable communication between the at least two segment controllers and the remote management system. The segment controllers may locally process at least some of the sensor data, thereby including less than all of the sensor data in the remote system data. The supplementary nodes, the lighting fixture nodes, the segment controllers, and the sensors may utilize a common data format to communicate with one another. Each of the supplementary nodes, the lighting fixture nodes, the segment controllers, and the sensors may transmit a signal having one of a plurality of device class sequences, whereby each of said device class sequences is indicative of a device class. For example, the supplementary nodes may each selectively transmit a signal having a supplementary node device class sequence that identifies the signal as being associated with a supplementary node.

Generally, in another aspect, a method of communication between a plurality of heterogeneous devices includes transmitting lighting fixture control data to at least one outdoor lighting fixture node, wherein the outdoor lighting fixture node controls at least one desired light output characteristic of at least one outdoor lighting fixture and wherein the light output characteristic of the at least one outdoor lighting fixture is based at least in part on the lighting fixture control data. The method further comprises transmitting supplementary control data to at least one outdoor supplementary node, wherein the outdoor supplementary node controls at least one control characteristic of at least one of a supplementary non-lighting system such as, for example, a security system, a traffic system, and an emergency response system. The control characteristic is based at least in part on the supplementary control data. The method further includes receiving segment controller data from a remote management system, wherein at least some of the lighting fixture control data and the supplementary control data are based at least in part on the segment controller data. The method further comprises receiving sensor data from a plurality of the sensors; transmitting remote system data to the remote management system, wherein the remote system data includes information indicative of the sensor data; locally processing at least some of the sensor data, thereby including less than all of the sensor data in the remote system data; and determining at least one of some of the lighting fixture control data and at least some of the supplementary control data independently of the segment controller data.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions.

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates a first embodiment of a scalable network of heterogeneous devices.

FIG. 2 illustrates a second embodiment of a scalable network of heterogeneous devices.

FIG. 3 illustrates one lighting node of the scalable network of heterogeneous devices of FIG. 2.

FIG. 4 illustrates one supplementary node of the scalable network of heterogeneous devices of FIG. 2.

FIG. 5 illustrates a first embodiment of a data format structure that may be utilized by one or more of the devices of the scalable network of heterogeneous devices.

FIG. 6 illustrates various aspects of identifying information data structure that may be utilized by one or more of the devices of the scalable network of heterogeneous devices.

FIG. 7 illustrates a second embodiment of a data format structure that may be utilized by one or more of the devices of the scalable network of heterogeneous devices.

### DETAILED DESCRIPTION

Sensor networks have been proposed that include a plurality of sensors deployed throughout a city. The sensors transmit sensor data to a remote server in order to monitor one or more environmental or other parameters in the city. In order to link the sensors to the remote server in a sensor network, it has been proposed to form an ad hoc network among the sensors and/or to utilize existing mobile cellular network technologies. However, such methodologies may have shortcomings with respect to efficiency and/or scalability. Outdoor lighting networks may provide a basis for a network architecture for a number of sensors. However, outdoor lighting networks are typically self contained and implemented separately from any sensor or other networks. Thus, Applicants have recognized and appreciated that it would be beneficial to provide a network that combines a large number of sensors and an outdoor lighting network, wherein the network enables efficient and scalable support of the sensors and the outdoor lighting fixture nodes of the outdoor lighting network.

More generally, Applicants have recognized and appreciated that it would be beneficial to have a scalable network of heterogeneous devices that includes at least one outdoor lighting fixture node.

In the following detailed description, for purposes of explanation and not limitation, representative embodiments disclosing specific details are set forth in order to provide a thorough understanding of the claimed invention. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the claimed invention. For example, various embodiments of the approach disclosed herein are particularly suited for a scalable network of sensor nodes and lighting nodes implemented in an outdoor environment throughout portions of a city. Accordingly, for illustrative purposes, the claimed invention is discussed in conjunction with such a network. However, other configurations and applications of this approach are contemplated without deviating from the scope or spirit of the claimed invention.

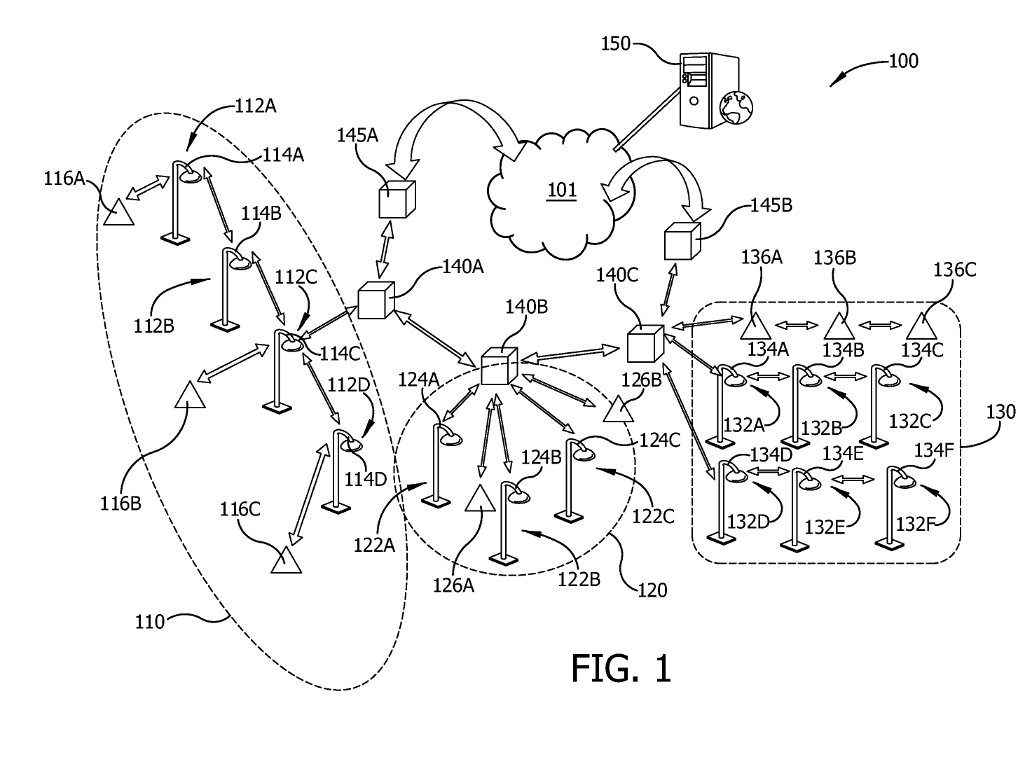

FIG. 1 illustrates a first embodiment of a scalable network of heterogeneous devices 100. The network 100 includes a plurality of street-lighting fixture nodes 112A-D in a first area 110. Each of the street lighting fixtures 114A-D may be placed adjacent a segment of a roadway and selectively illuminate a portion of the roadway. The first area 110 may generally define an area that includes and surrounds that segment of roadway. Each of the street-lighting fixture nodes 112A-D controls a corresponding single lighting fixture of street lighting fixtures 114A-D.

Each of the street lighting fixture nodes 112A-D is in direct communication with at least one other of the street lighting fixture nodes 112A-D, as indicated by the arrows extending therebetween. In particular, street lighting fixture node 112A is in direct communication with street lighting fixture node 112B, street lighting fixture node 112B is in direct communication with street lighting fixture nodes 112A and 112C, street lighting fixture node 112C is in direct communication with street lighting fixture nodes 112B and 112D, and street lighting fixture node 112D is in direct communication with street lighting fixture node 112C. Street lighting fixture node 112C is in direct communication with a first segment controller 140A and thereby indirectly links street lighting fixture nodes 112A, 112B, and 112C to the first segment controller 140A.

A plurality of sensors 116A-C are also provided in the first area 110. The sensors 116A-C include a motion sensor 116A, an air quality sensor 116B, and a visibility sensor 116C. The motion sensor 116A may be operably positioned to detect presence and/or motion of an object (e.g., a pedestrian or a vehicle) within a coverage range (e.g., a stretch of roadway). The motion sensor 116A may be, for example, one or more devices that detect motion and/or presence of an object through, for example, infrared light, laser technology, radio waves, a fixed camera, inductive proximity detection, a thermographic camera, and/or an electromagnetic or electrostatic field. The air quality sensor 116B may be, for example, one or more devices that detect the presence and/or concentration of certain gases and/or the presence and/or concentration of certain particulates. The visibility sensor 116C may be, for example, one or more devices that detect visual range through, for example, background luminance measurements via a photometric eye.

The motion sensor 116A is in direct communication with the lighting fixture node 112A and is thereby in indirect communication with segment controller 140A via lighting fixture nodes 112A-C. The air quality sensor 116B is in direct communication with the lighting fixture node 112C and is thereby in indirect communication with segment controller 140A via lighting fixture node 112C. The visibility sensor 116C is in direct communication with the lighting fixture node 112D and is thereby in indirect communication with segment controller 140A via lighting fixture nodes 112D and 112C.

The network 100 also includes a plurality of street-lighting fixture nodes 122A-C in a second area 120. Each of the street-lighting fixture nodes 122A-C controls a corresponding single lighting fixture of street lighting fixtures 124A-C. Each of the street lighting fixtures 124A-C may be placed throughout a public square and selectively illuminate a portion of the public square. The second area 120 may generally define an area that includes and surrounds the public square. Each of the street lighting fixture nodes 122A-C is in direct communication with a second segment controller 140B, as indicated by the arrows extending between the street lighting fixture nodes 122A-C and the second segment controller 140B.

A plurality of motion sensors 126A and 126B are also provided in the second area 120. The motion sensors 126A and 126B may be operably positioned to detect presence and/or motion of an object (e.g., a pedestrian or a vehicle) within a coverage range (e.g., a portion of the public square) and may detect motion utilizing, for example, one of the previously discussed methodologies. The motion sensors 126A and 126B are each in direct communication with the second segment controller 140B.

The network 100 also includes a plurality of street-lighting fixture nodes 132A-F in a third area 130. Each of the street-lighting fixture nodes 132A-F controls a corresponding single lighting fixture of street lighting fixtures 134A-F. Each of the street lighting fixtures 134A-F may be placed throughout a parking lot and selectively illuminate a portion of the parking lot. The third area 130 may generally define an area that includes and surrounds the parking lot. Each of the street lighting fixture nodes 132A-F is in communication with a third segment controller 140C. Street lighting fixture nodes 132A and 132D are in direct communication with third segment controller 140C. Street lighting fixture nodes 132B and 132E are in indirect communication with third segment controller 140C via street lighting fixture nodes 132A and 132D, respectively. Street lighting fixture node 132C is in indirect communication with third segment controller 140C via street lighting fixture nodes 132B and 132A and street lighting fixture node 132F is in indirect communication with third segment controller 140C via street lighting fixture nodes 132E and 132D.

A plurality of motion sensors 136A and 136B are also provided in the third area 130. The motion sensors 136A and 136B may be operably positioned to detect presence and/or motion of an object (e.g., a pedestrian or a vehicle) within a coverage range (e.g., a portion of the parking lot) and may detect motion utilizing, for example, one of the previously discussed methodologies. A visibility sensor 136C is also provided in the second area. The motion sensor 136A is in direct communication with the third segment controller 140C and the motion sensor 136B is in communication with the third segment controller 140C via motion sensor 136B. The visibility sensor 136C is in communication with the third segment controller 140C via motion sensors 136B and 136A.

The second segment controller 140B is in communication with the first segment controller 140A and in communication with the third segment controller 140C. The first segment controller 140A and the third segment controller 140C are in communication with one another via the second segment controller 140B. The first segment controller 140A and the third segment controller 140C are each in communication with respective of a first gateway 145A and a second gateway 145B. The first gateway 145A and second gateway 145B are each in communication with a remote management system 150 via a wide area network 101. Accordingly, each of the segment controllers 140A-C is in either direct or indirect communication with the remote management system 150. Moreover, the three segment controllers 140A-C only require two gateways 145A and 145B to access the wide area network 101. The second segment controller 140B may communicate with the remote management system 150 via first segment controller 140A and first gateway 145A and/or via third segment controller 140C and second gateway 145B. The wide area network 101 may be, for example, an intranet, the internet, and/or a cellular network.

Each of the lighting fixture nodes 112A-D, 122A-C, and 132A-F has been described as being associated with a single lighting fixture of lighting fixtures 114A-D, 124A-C, and 134A-F. However, it will be apparent to one having ordinary skill in the art having had the benefit of the present disclosure that in alternative embodiments one or more of the street-lighting fixture nodes 112A-D, 122A-C, and 132A-F may individually control a plurality of street lighting fixtures. Also, each of the sensors 116A-C, 126A-B, and 136A-C has been described as being separate from the lighting fixtures 114A-D, 124A-C, and 134A-F. However, it will be apparent to one having ordinary skill in the art having had the benefit of the present disclosure that in alternative embodiments one or more of the sensors 116A-C, 126A-B, and 136A-C may be coupled to one or more of the lighting fixtures 114A-D, 124A-C, and 134A-F.

Each of the lighting fixture nodes 112A-D, 122A-C, and 132A-F contains a controller that is in electrical communication with electronics of a corresponding single lighting fixture of respective street lighting fixtures 114A-D, 124A-C, and 134A-F and controls at least one light output characteristic of the corresponding single lighting fixture. For example, in some embodiments, the controller may communicate with the electronics to ensure a light source of a corresponding single lighting fixture of street lighting fixtures 114A-D, 124A-C, and 134A-F is producing a desired intensity of light output (e.g., no light output, full light output, 50% light output), a desired color of light output (e.g., red, green, a given color temperature of white light), and/or a desired light output pattern (e.g., IESNA Type I, II, III, IV, V). In some embodiments the electronics may include an LED driver and the light source may include a plurality of LEDs. The controller of each of the lighting fixture nodes 112A-D, 122A-C, and 132A-F may also optionally receive communication from electronics of a corresponding single lighting fixture of street lighting fixtures 114A-D, 124A-C, and 134A-F such as, for example, communication pertaining to light source status (e.g., on/off, functionality, hours in use), energy usage, and/or temperature (e.g., temperature within the housing).

Each of the sensors 116A-C, 126A-B, and 136A-C generates sensor data and transmits the sensor data, directly or indirectly, to at least one of the segment controllers 140A-C. Each of the lighting nodes 112A-D, 122A-C, and 132A-F may optionally transmit lighting node data to at least one of the segment controller 140A-C. The lighting node data may include, for example, information indicative of light source status, energy usage, and/or temperature of one or more associated lighting fixtures 114A-D, 124A-D, and 134A-F. The sensor data and/or the lighting node data may be transmitted, for example, at predetermined intervals, when measured data varies by a predetermined amount, and/or when a request is sent from a corresponding of the segment controllers 140A-C or from the remote management system 150. The sensors 116A-C, 126A-B, and 136A-C may also optionally receive data, directly or indirectly, from one of segment controllers 140A-C such as, for example, data pertaining to monitoring frequency and update frequency, or data for controlling the sensitivity or other operating parameters of the sensors.

The segment controllers 140A-C transmit remote system data to the remote management system 150 via at least one of the gateways 145A and 145B. The remote system data includes information indicative of the sensor data and/or the lighting node data. In some embodiments the remote system data may include the sensor data and/or the lighting node data verbatim. In other embodiments the remote system data may be a compressed version of the sensor data and/or the lighting node data. In yet other embodiments the remote system data may include less than all of the sensor data and/or the lighting node data. For example, instead of transmitting all of the sensor data, one or more of the segment controllers 140A-C may determine mean, median, and standard deviation values for a set of sensor data from one or more of the sensors 116A-C, 126A-B, and 136A-C and only transmit those values in the remote system data. Accordingly, less than all of the sensor data may be included in the remote system data and the amount of data that is transmitted from the segment controllers 140A-C to the remote management system 150 may be reduced. Also, for example, instead of transmitting all of the sensor data, one or more of the segment controllers 140A-C may only transmit sensor data that varies from previously transmitted sensor data by a threshold amount, thereby preventing transmission of sensor data that does not vary from previously transmitted sensor data by a threshold amount. Accordingly, less than all of the sensor data is included in the remote system data. Including less than all of the sensor data in the remote system data may reduce network traffic and/or may reduce any costs associated with access to the wide area network 101, thereby improving efficiency of the network 100.

The remote management system 150 is in communication with the gateways 145A and 145B via the wide area network 101. The remote management system 150 is also in communication with the segment controllers 140A-C via the gateways 145A and 145B. The remote management system 150 receives and analyzes the remote system data sent by the segment controllers 140A-C. For example, the remote management system 150 may receive remote system data that contains data indicative of sensor data from sensors 116A-C in the first area 110. The remote management system 150 may analyze the remote system data to determine, for example, the traffic volume over a period of time, the air quality over a period of time, the visibility over a period of time, the correlation between traffic volume and air quality, and/or the correlation between air quality and visibility.

The remote management system 150 also transmits segment controller data to segment controllers 140A-C. The segment controller data may be based on previously received remote system data and/or may be based on other data such as, for example, manually inputted information. The segment controllers 140A-C transmit lighting fixture control data to the lighting fixture nodes 112A-D, 122A-C, and 132A-F. The lighting fixture control data that is sent by the segment controllers 140A-C may be based at least in part on the segment controller data sent to the segment controllers 140A-C by the remote management system 150. For example, lighting fixture control data may at times be based solely on the segment controller data, may at times be based partly on the segment controller data, and may at times not be based on the segment controller data at all. The lighting fixture nodes 112A-D, 122A-C, and 132A-F may control at least one light output characteristic of the corresponding street lighting fixtures 114A-D, 124A-C, and 134A-F based at least in part on the lighting fixture control data. For example, lighting fixture control data may be sent to lighting fixture nodes 122A-C that contains information indicative of when lighting fixtures 124A-C should be illuminated at full power and when they should be illuminated at half power. Also, for example lighting fixture control data may be sent to the lighting fixture nodes 122A-C that contains information indicating that all lighting fixtures 124A-C should be illuminated at full power until farther notice. Such instructions may be appropriate during an emergency, special event, and/or period of poor visibility.

In some embodiments, the segment controllers 140A-C are operable to directly determine at least some of the lighting fixture control data independently of the remote management system 150. Accordingly, the amount and/or frequency of data transmission between the segment controllers 140A-C and the remote management system 150 may be reduced and costs associated with access to the wide area network 101 may also be reduced, thereby improving efficiency of the network 100. For example, one or more of the segment controllers 140A-C could use the sensor data from one or more of sensors 116A-C, 126A-B, and 136A-C to generate the lighting fixture control data independently of the remote management system. For instance, segment controller 140A could analyze the sensor data from visibility sensor 116C and generate lighting fixture control data that causes the light output intensity and/or light output color of lighting fixtures 114A-D to be adjusted to provide appropriate light output for recently measured visibility conditions. Such lighting fixture control data can be generated wholly or partially independently of communication with remote management system 150 and/or independently of previously received segment controller data of the segment controller 150. Moreover, instead of sending all the raw sensor data from sensor 116C to remote management system 150, segment controller 140A may only send a listing of those time periods for which visibility conditions were poor enough to require amended light output characteristics. Accordingly, less than all of the sensor data may be included in the remote system data sent from segment controller 140A to remote management system 150.

In another example, segment controller 140A could analyze the sensor data from motion sensor 116A to monitor traffic flow (e.g., volume and/or speed, etc) and adapt the output of lighting fixtures 114A-D according to traffic conditions without necessarily waiting for a command via segment controller data from the remote management system 150. In yet another example, segment controller 140C could analyze sensor data from motion sensors 136A and 136B to anticipate the direction of a detected object and increase the light output of selected of lighting fixtures 132A-F that may be in the path of the detected object without necessarily waiting for a command via segment controller data from the remote management system 150. The segment controllers 140A-C being operable to directly determine at least some of the lighting fixture control data independently of the remote management system 150 also enables the segment controllers 140A-C to operate independently when, for example, communication between the remote management system 150 and the segment controllers 140A-C is malfunctioning.

Data may be communicated between the various lighting fixture nodes 112A-D, 122A-C, and 132A-F, sensors 116A-C, 126A-B, and 136A-C, segment controllers 140A-C, gateways, 145A-C, and/or remote management system 150 over any physical medium, including, for example, twisted pair coaxial cables, fiber optics, or a wireless link using, for example, infrared, microwave, encoded LED data via modulation of a LED light source, and/or radio frequency transmissions. Also, any suitable transmitters, receivers or transceivers may be used to effectuate communication in the network 100. Moreover, any suitable protocol may be used for data transmission, including, for example, TCP/IP, variations of Ethernet, Universal Serial Bus, Bluetooth, FireWire, Zigbee, DMX, 802.11b, 802.11a, 802.11g, 802.15.4, token ring, a token bus, serial bus, or any other suitable wireless or wired protocol. The network 100 may also use combinations of physical media and data protocols.

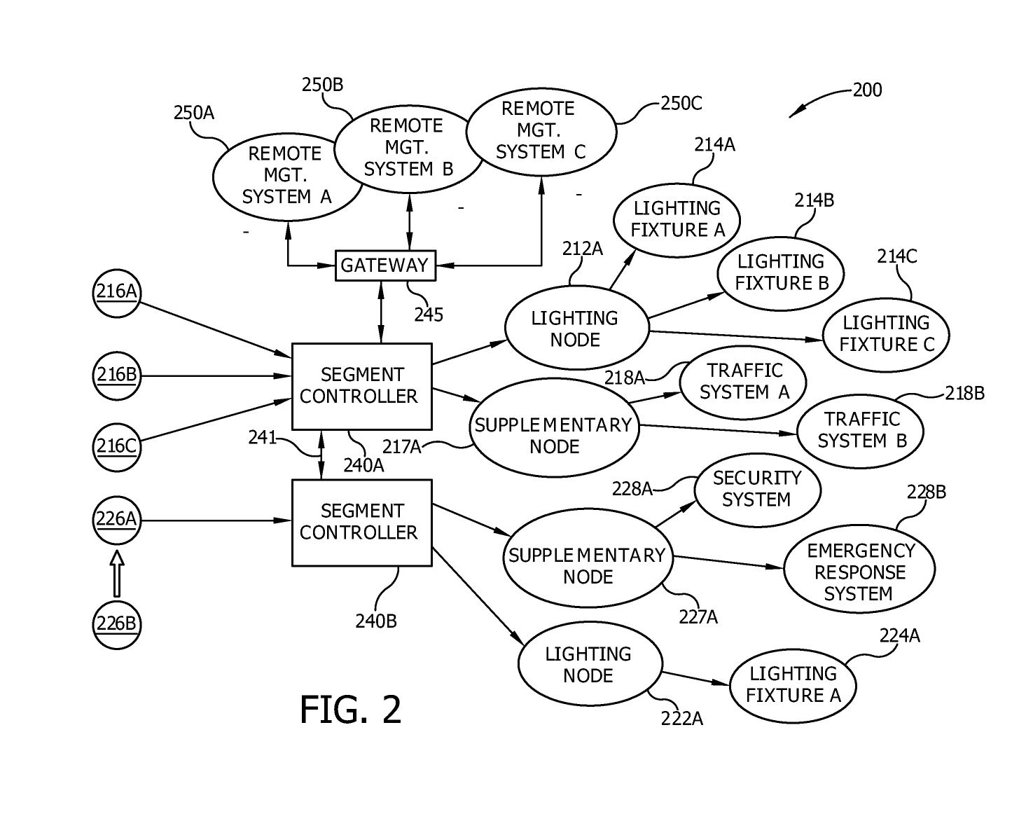

FIG. 2 illustrates a second embodiment of a scalable network of heterogeneous devices 200. The network 200 includes three sensors 216A-C each transmitting sensor data directly to a first segment controller 240A. The lighting node 212A may optionally be operable to transmit information to the segment controller 240A such as, for example, light source status information of any of lighting fixtures A-C 214A-C. The network 200 also includes two sensors 226A and 226B each transmitting sensor data to a second segment controller 240B. Sensor 226A is transmitting sensor data directly to second segment controller 240B and sensor 226B is transmitting sensor data to second segment controller 240B via sensor 226A. Each of the sensors 216A-C, 226A, and 226B may be any desired type of sensor such as, for example, a motion sensor, air quality sensor, visibility sensor, light sensor, humidity sensor, temperature sensor, or acoustic sensor.

The second segment controller 240B transmits lighting fixture control data to a lighting node 222A that is controlling at least one light output characteristic of lighting fixture A 224A. The lighting node 222A controls lighting fixture A 224A based at least in part on the lighting fixture control data transmitted thereto by the second segment controller 240B.

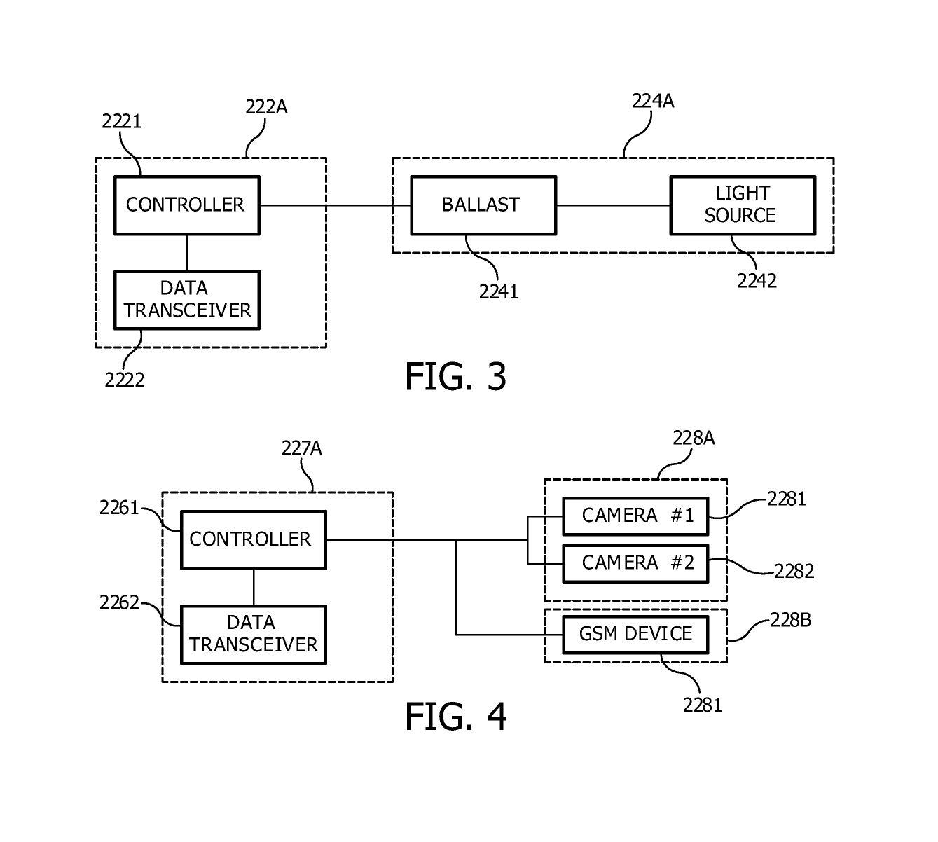

Referring briefly to FIG. 3, the lighting node 222A and lighting fixture 224A are shown in additional detail. The lighting node 222A includes a controller 2221 that is in communication with a ballast 2241 of lighting fixture 224A. The ballast 2241 is in electrical communication with a light source 2242 of the lighting fixture 224A. The controller 2221 communicates with the ballast 2241 to thereby control at least one light output characteristic of the light source. For example, in some embodiments, the controller 2221 may communicate with a control input of the ballast 2241 to cause the light source 2242 to produce a desired intensity of light output. The controller 2221 is also in communication with a data transceiver 2222 which may transmit data to and receive data from segment controller 240B.

Referring again to FIG. 2, the first segment controller 240A transmits lighting fixture control data to a lighting node 212A that is controlling at least one light output characteristic of lighting fixtures A-C 214A-C. The segment controllers 240A and 240B are in communication with one another and in communication with remote management systems A-C 250A-C via gateway 245. Remote management systems A-C 250A-C may be separate systems or may be separate aspects of a common management system. The segment controllers 240A and 240B transmit segment controller data to remote management systems A-C 250A-C that is indicative of sensor data received from sensors 216A-C, 226A, and 226B. Remote management system A 250A is a remote management lighting system and transmits lighting segment controller data to segment controllers 240A and 240B. The lighting segment controller data may be based on previously received remote system data and/or may be based on other data such as, for example, manually inputted information.

The lighting fixture control data sent by segment controllers 240A and 240B to respective of lighting nodes 212A and 222A may be based at least in part on the lighting segment controller data from remote management system A 250A. For example, lighting fixture control data may at times be based solely on the lighting segment controller data, may at times be based partly on the lighting segment controller data, and may at times not be based on the lighting segment controller data at all. Also, as described with respect to the network 100 of FIG. 1, segment controller 240A and/or segment controller 240B may be operable to directly determine at least some of the lighting fixture control data independently of the remote management system 250A. For example, segment controller 240B may analyze sensor data from one or more of sensors 216A-C, 226A, and 226B and determine the lighting fixture data sent to lighting node 222A based at least in part on the independent analysis of the sensor data.

The network 200 also includes a supplementary node 217A that is controlling at least one control characteristic of a traffic system A 218A and a traffic system B 218B. For example, the supplementary node 217A may control the cycling time of one or more of the traffic lights of traffic system B 218B and/or control the activation of one or more traffic cameras of traffic system B 218B. The first segment controller 240A transmits supplementary control data to the supplementary node 217A. The supplementary node 217A controls traffic system A 218A and/or a traffic system B 218B based at least in part on the supplementary control data. The supplementary node 217A may optionally be operable to transmit information to the segment controller 240A such as, for example, traffic system status information of traffic system A and/or B 218A and 218B. Remote management system B 250B is a remote management traffic control system and transmits traffic segment control data to segment controller 240A. The traffic segment controller data may be indicative of proper control parameters of traffic system B 218B and be based on previously received remote system data and/or may be based on other data such as, for example, manually inputted information.

The supplementary control data sent by segment controller 240A to supplementary node 217A may be based at least in part on the traffic segment controller data from remote management system B 250B. For example, supplementary control data may at times be based solely on the traffic segment controller data, may at times be based partly on the traffic segment controller data, and may at times not be based on the traffic segment controller data at all. Also, segment controller 240A and/or segment controller 240B may be operable to directly determine at least some of the supplementary control data independently of the remote management system B 250B. For example, segment controller 240A may analyze sensor data from one or more of sensors 216A-C, 226A, and 226B and determine the supplementary control data based at least in part on the independent analysis of the sensor data. For example, sensor data may indicate heavy traffic approaching traffic system A 218A and segment controller 240A may send supplementary control data to supplementary node 216A that adjusts the traffic lights appropriately to better handle flow of the approaching traffic.

The network 200 also includes a supplementary node 227A that is controlling at least one control characteristic of a security system 228A and an emergency response system 228B. Referring briefly to FIG. 4, the supplementary node 227A, security system 228A, and emergency response system 228B are shown in additional detail. The supplementary node 227A includes a controller 2261 that is in communication with a data transceiver 2262 which may transmit data to and receive data from segment controller 240B. The controller 2261 is also in communication with a first camera 2281 and a second camera 2282 of the security system 228A and a GSM device 2281 of the emergency response system 228B. The controller 2261 may control the first camera 2281 and/or the second camera 2282. For example, the controller 2261 may cause the first camera 2281 and/or the second camera 2282 to be activated and/or may alter the viewing direction of first camera 2281 and/or the second camera 2282. The controller 2261 may also control the GSM device 2281. For example, the controller 2261 may cause the GSM device 2281 to contact an emergency dispatch center and relay information to the emergency dispatch center. In other embodiments a non-GSM communication device may be utilized to connect to public safety networks. Also, in some embodiments the controller 2261 may additionally or alternatively transmit a message to one or more of the remote management systems A-C 250A-C. The one or more remote management systems A-C 250A-C may then contact the emergency dispatch center via, for example, a wide area network.

Referring again to FIG. 2, remote management system C 250C is a remote management surveillance/emergency response control system and transmits surveillance segment control data to segment controller 240B. Remote management system C 250C may also optionally display surveillance reports and/or other information to users/operators of remote management system C 250C. The surveillance segment control data may be indicative of desired control parameters of the security system 228A and may be based on previously received remote system data and/or may be based on other data such as, for example, manually inputted information. The supplementary control data sent by segment controller 240B to supplementary node 227A may be based at least in part on the surveillance segment controller data from remote management system C 250C. For example, supplementary control data may at times be based solely on the surveillance segment controller data, may at times be based partly on the surveillance segment controller data, and may at times not be based on the surveillance segment controller data at all. Also, segment controller 240A and/or segment controller 240B may be operable to directly determine at least some of the supplementary control data independently of the remote management system C 250C. For example, segment controller 240B may analyze sensor data from one or more of sensors 216A-C, 226A, and 226B and determine the supplementary control data sent to supplementary node 227A based at least in part on the independent analysis of the sensor data. For example, sensor data may indicate motion in a given area near the first camera 2281 and segment controller 240B may send supplementary control data to supplementary node 227A that activates the first camera 2281. In some embodiments the supplementary node 227A may send a request to the segment controller 240B to increase light output in the area proximal the first camera 2281 to improve the conditions for image capture by the first camera 2281. For example, in some embodiments lighting fixture A 224A may be proximal the first camera 2281 and the segment controller 240B may increase the light output of lighting fixture A 224A to improve the image capture from the first camera 2281. The request for increased light output may be generated by, for example, the supplementary node 227A or by the security system 228A.

In some embodiments, supplementary node 227A may be operable to control security system 228A and/or emergency response system 228B wholly or partially independently of the supplementary control data. For example, the supplementary node 227A may receive sensor data from one or more of sensors 216A-C and 226A-B and control the security system 228A based at least in part on the received sensor data. The sensor data may be received directly from one or more of sensors 216A-C and 226A-B and/or may be received via segment controller 240A and/or segment controller 240B. Similarly, supplementary node 217A may optionally be operable to control traffic system A 218A and/or traffic system B 218B wholly or partially independently of the supplementary control data. For example, the supplementary node 217A may control traffic system A 218A and/or traffic system B 218B based on a default control parameters and/or received sensor data. Accordingly, supplementary nodes 217A and 227A may be operable to operate independently of segment controllers 240A and 240B. The various lighting nodes described herein may also optionally be operable to control lighting fixtures thereof wholly or partially independently of lighting fixture control data.

As described with respect to network 100 in FIG. 1, data may be communicated between the various elements of network 200 in FIG. 2 over any physical medium. Also, any suitable transmitters, receivers or transceivers may be used to effectuate communication in the network 200. Moreover, any suitable protocol may be used for data transmission.

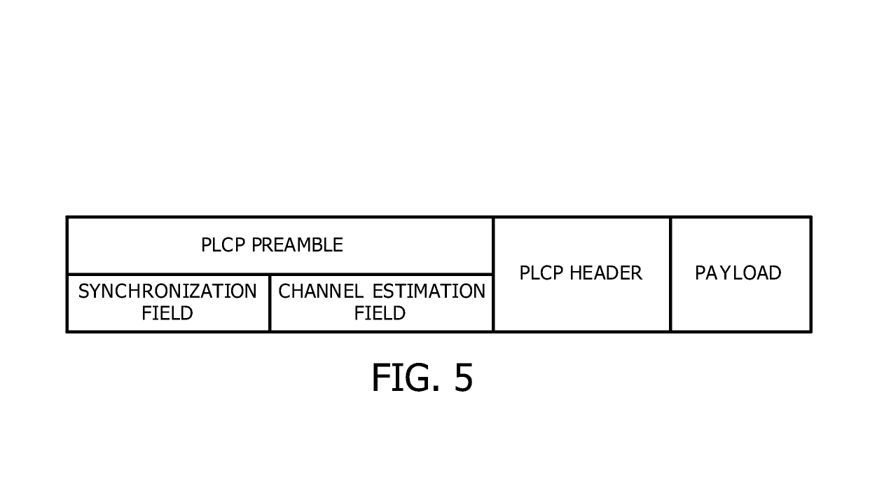

Referring now to FIG. 5 through FIG. 7, aspects of a communication system that may be utilized by one or more of the devices of the scalable network of heterogeneous devices 100 or 200 is shown. The communication system may define different device classes in the network 100 or 200 and may allow heterogeneous devices to join the network, transmit/receive information, and also make use of the information being shared. In other words, the various devices of the networks 100 and 200 (segment controllers, sensors, lighting nodes, etc.) should be able to exchange information and “understand” the information being exchanged regardless of the particular application. The communication system may support a variety of devices types, with distinct capabilities and allow new device types to be easily incorporated with minimal changes to existing network components and protocols. The communication system may enable all the devices in network 100 or 200 to identify each others' transmissions and enable efficient communication and useful information exchange among various devices.

Referring now to FIG. 5, a first embodiment of a data format structure that may be utilized by one or more of the devices of the scalable network of heterogeneous devices 100 or 200 is shown. Device classes A, B, and C may be defined in the network 100 or 200. Class A devices may support low data rate communications over large distances. Class B devices may support high data rate communications over short distances. Class C devices may support low data rate communications over short distances. The segment controllers 140A-C and 240A-B may support communication with all device classes. The communication system may enable all the devices in network 100 or 200 to identify each others' device class and enables efficient communication between the devices. The data format structure shown in FIG. 5 includes a Physical Layer Convergence Protocol (PLCP) Preamble that includes a synchronization field and a channel estimation field. The PLCP Preamble is used to distinguish among different device classes. For example, multiple orthogonal pseudo noise (PN) sequences can be defined corresponding to the different device classes. A transmitting device can transmit a signal having a PN sequence corresponding to one of the different device classes. A receiving device would receive the signal from the transmitting device, correlate the received signal with the expected PN sequences, and pick the one with maximum peak value to determine the class of the device. The PLCP Header and the Payload fields of the data format structure can be encoded using a defined modulation and coding scheme and transmitted at the appropriate data rate and power as required by that particular device class.

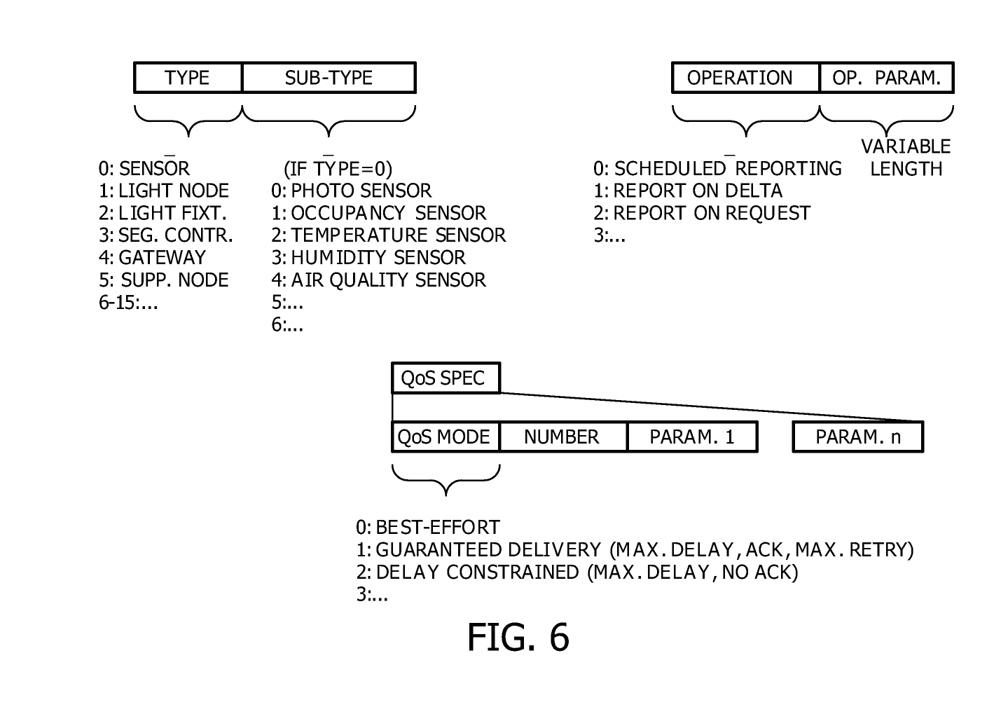

Referring now to FIG. 6, various aspects of identifying information data structure that may be utilized by one or more of the devices of the scalable network of heterogeneous devices are shown. The identifying information data structure includes Device Type Identification that includes a device TYPE identification field and a device SUB-TYPE identification field. The device TYPE field identifies the general group of device (e.g., sensor, lighting node, lighting fixture, segment controller, gateway). The device SUB-TYPE field identifies the sub-group of device (e.g., if TYPE is a sensor, then SUB-TYPE may include, photo sensor, occupancy sensor, temperature sensor, humidity sensor, air quality sensor).

The identifying information data structure also includes Operation Modes Identification that includes a device OPERATION field and optionally a variable length OP. PARAM. The device OPERATION field defines the operation mode for the device. For example, a sensor may report sensor data on a scheduled reporting basis, may report sensor data when a threshold change in sensor readings occurs, or may report sensor data when requested by another device (e.g., a segment controller or supplementary node). The OP. PARAMETERS field may include one or more associated operation parameters. For example, the scheduled reporting basis may have one or more OP. PARAMETERS that defines the specific reporting schedule or provides a list of potential reporting schedules that may be selected by, for example, a segment controller.

The identifying information also includes Quality of Service (QoS) Identification that includes a QoS MODE field, a Parameters NUMBER field, and optionally fields for PARAMETERS 1-n. The QoS MODE field defines the level of quality of service that is expected from the one or more devices with which a device is connected. For example, the quality of service expected by a device may be best-effort, guaranteed delivery, or delay constrained. Each QoS mode may have a number of parameters associated with it. The specific number of any such parameters will be indicated in the Parameters NUMBER field and the parameters will be contained in the PARAMETERS 1-n field(s). The QoS field may be used by protocols in the lower layers of the stack (e.g. network or MAC layers) to provision QoS for the data generated by (or destined to) a particular device. Accordingly, efficient cross-layer specification key communication needs may be obtained.

The identifying information shown in FIG. 6 may be used during the initial configuration phase of a given device. In order to join a network, devices may include their identifying information in the network association request messages. Furthermore, a device may support multiple operation modes and/or multiple QoS modes and it may include all its capabilities by advertising its multiple operation modes and/or multiple QoS modes during the network initialization process. A device may additionally or alternatively advertise its multiple operation modes and/or multiple QoS modes during normal operation so that other nodes may discover the device and optionally make use of information generated by the device. In the case of a plurality of operation modes (or multiple QoS), the particular operation mode (or QoS) and corresponding parameters should be configured through a negotiation procedure with the device and the other device(s) with which it communicates (for example, a segment controller or supplementary node). This enables the operation and communications modes to be configured when a device joins a network.

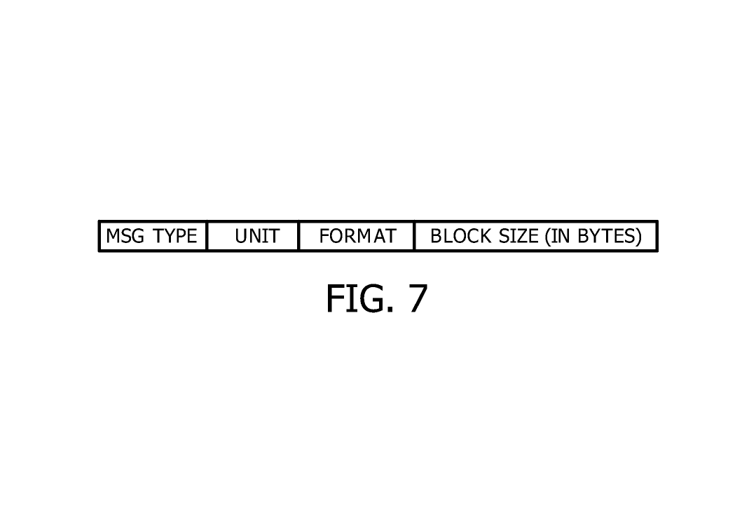

FIG. 7 illustrates a second embodiment of a data format structure that may be utilized by one or more of the devices of the scalable network of heterogeneous devices. Prior to transmitting any data, a device may specify the data format of the upcoming data using the data format structure shown in FIG. 7. The data format could be acknowledged by the target device before the start of actual data transmissions. For instance, after joining the network and configuring the operation and communication modes to be used, a sensor may transmit the data format structure shown in FIG. 7 to a segment controller. The data format structure specifies the format of the data carried in the payload of the upcoming application protocol packets. In particular, the data format structure specifies the message type, unit, format, and block size of the upcoming protocol packets. After receiving an acknowledgement from the segment controller, the sensor could start generating data according to the agreed format, that is, in blocks of the specified size and with the unit and format indicated in the data format structure. Multiple data blocks could be included in a single application message, but this should be indicated by a block number field in the application message, and each block should follow the previously negotiated format.

Utilizing one or more aspects of the communications system described herein allows multiple heterogeneous devices to communicate with one another. Moreover, the communications system enables heterogeneous devices to be efficiently added to a network.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

Reference numerals, if any, are provided in the claims merely for convenience and are not to be read in any way as limiting.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

We claim:

1. A scalable network of heterogeneous devices, said network comprising:
a plurality of outdoor lighting fixture nodes, each of said outdoor lighting fixture nodes controlling at least one light output characteristic of at least one outdoor lighting fixture;
a plurality of segment controllers, each of said segment controllers transmitting lighting fixture control data to at least one of said outdoor lighting fixture nodes;
wherein said light output characteristic of said at least one outdoor lighting fixture is based at least in part on said lighting fixture control data;
at least one gateway in communication with at least two of said segment controllers;
at least one remote management system in communication with said gateway and in communication with said segment controllers via said gateway;
wherein said remote management system transmits segment controller data to said segment controllers and at least some of said lighting fixture control data is based at least in part on said segment controller data;
a plurality of sensors transmitting sensor data to at least one of said segment controllers;
wherein said segment controllers transmit remote system data to said remote management system via said gateway, said remote system data including information indicative of said sensor data;
wherein said segment controllers locally process at least some of said sensor data and include less than all of said sensor data in said remote system data; and
wherein said segment controller directly determines at least some of said lighting fixture control data based on said sensor data.

2. The network of claim 1 wherein at least some of said sensors transmit said sensor data directly to at least one of said segment controllers.

3. The network of claim 2 wherein at least some of said sensors transmit said sensor data to at least one of said segment controllers via at least one of said lighting fixture nodes.

4. The network of claim 1 wherein said segment controllers may operate in an independent mode independently of communication with said remote management system.

5. The network of claim 4 wherein in said independent mode said lighting fixture control data is determined independently of said segment controller data.

6. The network of claim 1 wherein said sensors selectively transmit identifying information to at least one of said segment controllers, said identifying information including type, at least one operation mode, and at least one quality of service mode.

7. The network of claim 6 wherein said identifying information includes a plurality of said operation mode and a plurality of said quality of service mode.

8. The network of claim 1 wherein a plurality of said segment controllers are each in communication with at least one other of said segment controllers.

9. A scalable network of heterogeneous devices, said network comprising:
a plurality of outdoor lighting fixture nodes, each of said outdoor lighting fixture nodes controlling at least one light output characteristic of at least one outdoor lighting fixture;
a plurality of outdoor supplementary nodes, at least one of said outdoor supplementary nodes controlling at least one control characteristic of at least one of a security system, a traffic system, and an emergency response system;
a plurality of segment controllers transmitting lighting fixture control data to at least one of said outdoor lighting fixture nodes and transmitting supplementary control data to at least one of said outdoor supplementary nodes;
wherein said light output characteristic is based at least in part on said lighting fixture control data;
wherein said control characteristic is based at least in part on said supplementary control data;
at least one remote management system in communication with said segment controllers;
wherein said remote management system transmits segment controller data to said segment controllers, wherein at least some of said lighting fixture control data and said supplementary control data are based at least in part on said segment controller data;
a plurality of sensors transmitting sensor data to at least one of said segment controllers;
wherein said segment controllers transmit remote system data to said remote management system, said remote system data indicative of said sensor data; and
wherein said segment controllers determine at least one of at least some of said lighting fixture control data and at least some of said supplementary control data independently of said segment controller data.

10. The network of claim 9 wherein at least some of said sensors transmit said sensor data to at least one of said segment controllers via at least one of said lighting fixture nodes.

11. The network of claim 10 wherein at least some of said sensors transmit said sensor data directly to at least one of said segment controllers.

12. The network of claim 9 wherein said sensors selectively transmit identifying information to at least one of said segment controllers, said identifying information including at least two of type, at least one operation mode, and at least one quality of service mode.

13. The network of claim 12 wherein said supplementary nodes have said identifying information and selectively transmit said identifying information to at least one of said segment controllers.

14. The network of claim 13 wherein said identifying information includes a plurality of said operation mode and a plurality of said quality of service mode.

15. The network of claim 9 further comprising at least one gateway in communication with at least two of said segment controllers and said remote management system, said gateway enabling communication between said segment controllers and said remote management system.

16. The network of claim 9 wherein said segment controllers locally process at least some of said sensor data, thereby including less than all of said sensor data in said remote system data.

17. The network of claim 9, wherein said supplementary nodes, said lighting fixture nodes, said segment controllers, and said sensors utilize a common data format to communicate with one another and each transmit a signal having one of a plurality of device class sequences, whereby each of said device class sequences is indicative of a device class.

18. A method of communication between a plurality of heterogeneous devices, said method comprising:
transmitting lighting fixture control data to at least one outdoor lighting fixture node, said outdoor lighting fixture node controlling at least one desired light output characteristic of at least one outdoor lighting fixture;
wherein said light output characteristic of said at least one outdoor lighting fixture is based at least in part on said lighting fixture control data;
transmitting supplementary control data to at least one outdoor supplementary node, said outdoor supplementary node controlling at least one control characteristic of at least one of a security system, a traffic system, and an emergency response system;
wherein said control characteristic is based at least in part on said supplementary control data;
receiving segment controller data from a remote management system, wherein at least some of said lighting fixture control data and said supplementary control data are based at least in part on said segment controller data;
receiving sensor data from a plurality of said sensors;
transmitting remote system data to said remote management system, said remote system data including information indicative of said sensor data;
locally processing at least some of said sensor data, thereby including less than all of said sensor data in said remote system data; and
determining at least one of some of said lighting fixture control data and at least some of said supplementary control data independently of said segment controller data.
